(19) United States
(12) Patent Application Publication
(10) Pub. No.: US 2024/0400091 A1
(43) Pub. Date: Dec. 5, 2024

(54) CONTROL DEVICE AND CONTROL METHOD

(71) Applicant: TOYOTA JIDOSHA KABUSHIKI KAISHA, Toyota-shi (JP)

(72) Inventors: Go INOUE, Gotemba-shi (JP); Noritsugu IWAZAKI, Shizuoka-ken (JP); Takeshi KANOU, Seto-shi (JP); Yoshinori WATANABE, Isehara-shi (JP); Yuki OKAMOTO, Kanagawa-ken (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/663,286

(22) Filed: May 14, 2024

(30) Foreign Application Priority Data
May 31, 2023 (JP) 2023-089971
Jan. 17, 2024 (JP) 2024-005178

(51) Int. Cl. B60W 60/00; B60W 30/14; B60W 50/14

(52) U.S. Cl. CPC B60W 60/001; B60W 30/143; B60W 50/14

(57) ABSTRACT

A control device includes: a determination unit for determining an action to be performed by a moving object, wherein the moving object is operable by unmanned driving; a control unit for causing a controlled moving object to perform the action while the controlled moving object is moving; an action information acquisition unit for acquiring an action information, wherein the action information is an information regarding the action that is observed from the outside a moving object; and a judgement unit for judging whether or not the controlled moving object has performed the action using the action information, wherein when the judgement unit judges that the controlled moving object has not performed the action, the control unit executes at least one of a process of notifying occurrence of abnormality, a process of stopping the controlled moving object, and a process of changing a speed of the controlled moving object.

### CROSS REFERENCE TO RELATED APPLICATIONS

The patent application claims the priority based on Japanese Patent Applications No. 2023-089971 filed on May 31, 2023, and No. 2024-005178 filed on Jan. 17, 2024, the disclosure of which are hereby incorporated by reference in their entireties.

### BACKGROUND

### Field

The present disclosure relates to a control device and a control method.

There is a known technology for confirming whether or not an intended vehicle is remotely controlled by transmitting a command to move vehicle wipers and the like by remote control, and observing whether or not the vehicle wipers and the like move in response to the command (for example, U.S. Pat. No. 10,532,771 B2).

In the technology described above, when the vehicle has not operated in response to the command, it has not been fully studied how the vehicle should be.

### SUMMARY

The present disclosure may be realized by the following aspects.

(1) According to a first aspect of the present disclosure, a control device is provided. The control device comprises: a determination unit configured to determine an action to be performed by a moving object, wherein the moving object is operable by unmanned driving; a control unit configured to cause a controlled moving object to perform the action while the controlled moving object is moving, wherein the controlled moving object is a moving object that is operated by the unmanned driving; an action information acquisition unit configured to acquire an action information, wherein the action information is an information regarding the action that is observed from the outside a moving object; and a judgement unit configured to judge whether or not the controlled moving object has performed the action using the action information, wherein when the judgement unit judges that the controlled moving object has not performed the action, the control unit executes at least one of a process of notifying occurrence of abnormality, a process of stopping the controlled moving object, and a process of changing a speed of the controlled moving object.

According to the control device of this form, when the judgement unit judges that the controlled moving object has not performed the action, it is possible to appropriately cope.

(2) In the control device according to the aspect described above, the controlled moving object may be a part of a plurality of moving objects operable by the unmanned driving, the control device may further comprise an identification unit configured to identify the controlled moving object from among the plurality of the moving objects using the action information, wherein when the judgement unit judges that the controlled moving objects has not performed the action, the identification unit identifies the controlled moving object from among the plurality of the moving objects.

According to the control device of this form, it is possible to identify the controlled moving object from among the plurality of the moving objects, when the judgement unit judges that the controlled moving object has not performed the action. Therefore, it is possible to further appropriately cope, when the judgement unit judges that the controlled moving object has not performed the action.

(3) In the control device according to the aspect described above, the controlled moving object may be a part of a plurality of moving objects operable by the unmanned driving, when the judgement unit judges that the controlled moving objects has not performed the action, the control unit may move the controlled moving object to a predetermined escape place.

According to the control device of this form, it is possible to further appropriately cope, when the judgement unit judges that the controlled moving object has not performed the action.

(4) In the control device according to the aspect described above, the control device may further comprise a process information acquisition unit configured to acquire a process information, the process information is an information regarding a progress of a manufacturing process of the moving object, and the determination unit may determine the action according to the progress indicated in the process information.

According to the control device of this form, it is possible to increase the judgement accuracy of whether or not controlling the intended moving object.

(5) According to a second aspect of the present disclosure, a control method is provided. The control method comprises: determining an action to be performed by a moving object, wherein the moving object is operable by unmanned driving; operating a controlled moving object, wherein the operating causes the controlled moving object to perform the action while the controlled moving object is moving, wherein the controlled moving object is a moving object that is operated by the unmanned operation; acquiring an action information, wherein the action information is an information regarding the action that is observed from the outside a moving object; and judging whether or not the controlled moving object has performed the action using the action information, wherein when the judging judges that the controlled moving object has not performed the action, the operating executes at least one of a process of notifying occurrence of abnormality, a process of stopping the controlled moving object, and a process of changing a speed of the controlled moving object.

According to the control method of this form, when the judging judges that the controlled moving object has not performed the action, it is possible to appropriately cope.

The present disclosure may also be implemented in various aspects other than control devices and control methods. For example, the present disclosure may also be implemented in aspects including an unmanned driving system, a moving object, a method for producing a moving object, a vehicle, a method for producing a vehicle, a computer program, a storage medium storing a computer program, and the like.

### BRIEF DESCRIPTION OF THE DRAWINGS

FIG. 1 is an explanatory view showing a configuration of an unmanned operation system of a first embodiment;

FIG. 2 is an explanatory view showing a configuration of a vehicle of the first embodiment;

FIG. 3A is an explanatory view showing how the vehicle moves by remote control in a factory;

FIG. 3B is a flowchart showing a processing procedure of a travel control of the vehicle of the first embodiment;

FIG. 4 is a flow chart showing contents of a confirmation process of the first embodiment;

FIG. 5 is a flowchart showing contents of a confirmation action execution process of the first embodiment;

FIG. 6 is an explanatory diagram showing contents of a table showing relationship between manufacturing processes of the vehicle and confirmation actions;

FIG. 7 is an explanatory diagram showing how to check the remote control object;

FIG. 8 is an explanatory view showing a configuration of an unmanned operation system of a second embodiment;

FIG. 9 is an explanatory view showing a configuration of a vehicle of the second embodiment;

FIG. 10 is a flowchart showing a processing procedure of a travel control of the vehicle of the second embodiment; and

FIG. 11 is a flowchart showing contents of a confirmation process of the second embodiment.

### DETAILED DESCRIPTION

### A. First Embodiment

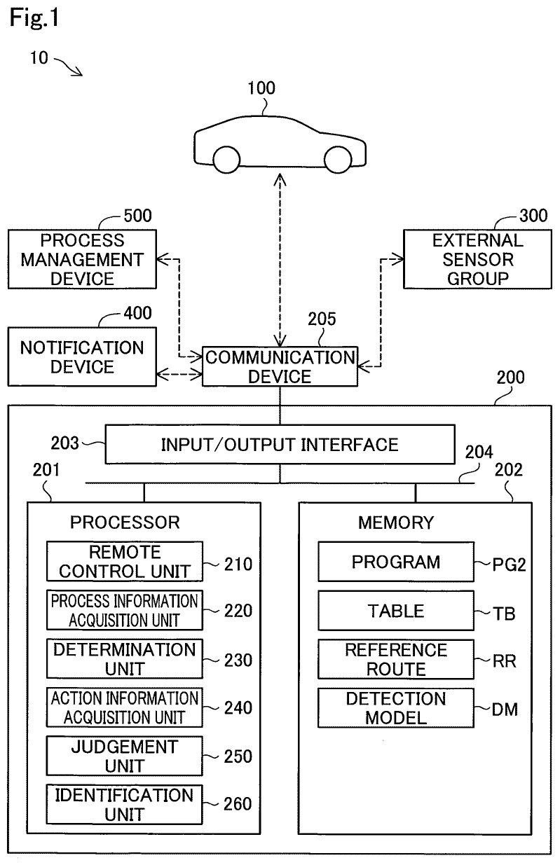

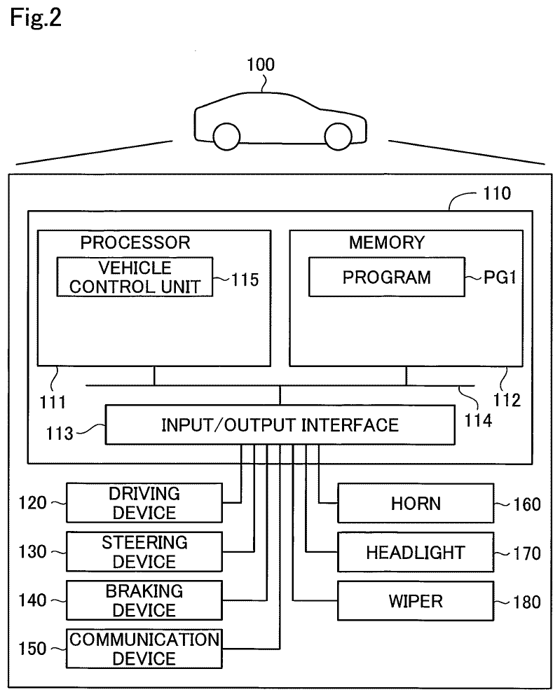

FIG. 1 is an explanatory view of a structure of an unmanned driving system 10 according to the first embodiment. FIG. 2 is an explanatory view of a structure of a vehicle 100 according to the first embodiment. The unmanned driving system 10 is used to move a moving object by unmanned driving. In the present embodiment, the unmanned driving system 10 is used in a factory for producing moving objects in order to move the moving objects by unmanned driving. Note that, the unmanned driving system 10 may be used to move moving objects by unmanned driving not only in factories where moving objects are produced, but also, for example, in commercial facilities, universities, parks, and the like.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a construction vehicle, or a combat vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

As shown in FIG. 1, in the present embodiment, the unmanned driving system 10 includes at least one vehicle 100, a remote control device 200 for remotely controlling vehicle 100, an external sensor group 300 provided in a factory, a notification device 400 for reporting occurrence of abnormality in the factory, and a process management device 500 for managing the production steps of the vehicle 100 in the factory. The remote control device 200 may also be simply referred to as a control device. In the present embodiment, the remote control device 200 corresponds to the “control device” of the present disclosure.

As shown in FIG. 2, in the present embodiment, the vehicle 100 is an electric vehicle configured to be operable by remote control. The vehicle 100 includes a vehicle control device 110 for controlling respective sections of the vehicle 100, a driving device 120 for accelerating the vehicle 100, a steering device 130 for changing the traveling direction of the vehicle 100, a braking device 140 for decelerating the vehicle 100, a communication device 150 for enabling communication with the remote control device 200 via wireless communication, a horn 160 for generating a warning sound, a headlamp 170 for irradiating light in front of the vehicle 100, and a wiper 180 for wiping off water droplets attached to the windows of the vehicle 100. In the present embodiment, the driving device 120 includes a battery, a driving motor driven by electric power of the battery, and driving wheels rotated by the driving motor.

The vehicle control device 110 is constituted of a computer with a processor 111, a memory 112, an input/output interface 113, and an internal bus 114. The processor 111, the memory 112, and the input/output interface 113 are connected via the internal bus 114 to enable bidirectional communication. The input/output interface 113 is connected to the driving device 120, the steering device 130, the braking device 140, the communication device 150, the horn 160, the headlamp 170, and the wiper 180. A computer program PG1 is stored in the memory 112.

The processor 111 functions as a vehicle control unit 115 by executing the computer program PG1. The vehicle control unit 115 controls the driving device 120, the steering device 130, the braking device 140, the horn 160, the headlamp 170, and the wiper 180. When the vehicle 100 has a driver, the vehicle control unit 115 is capable of enabling the vehicle 100 to run by controlling the driving device 120, the steering device 130, and the braking device 140 in response to operations by the driver. The vehicle control unit 115 is capable of enabling the vehicle 100 to run by controlling the driving device 120, the steering device 130, and the braking device 140 in response to control commands transmitted from the remote control device 200, regardless of whether or not the vehicle 100 has a driver.

As shown in FIG. 1, the remote control device 200 is constituted of a computer with a processor 201, a memory 202, an input/output interface 203, and an internal bus 204. The processor 201, the memory 202, and the input/output interface 203 are connected via the internal bus 204 to enable bidirectional communication. The input/output interface 203 is connected to a communication device 205 for enabling communication with the vehicle 100 via wireless communication. In the present embodiment, the communication device 205 is capable of communication with the external sensor group 300, the notification device 400, and the process management device 500 via wired or wireless communication. A computer program PG2 and a table TB are stored in the memory 202.

The processor 201 functions as a remote control unit 210, a process information acquisition unit 220, a determination unit 230, an action information acquisition unit 240, a judgement unit 250, and an identification unit 260 by executing the computer program PG2. The remote control unit 210 drives the vehicle 100 by remotely controlling the vehicle 100. The process information acquisition unit 220 acquires process information that is information indicating the progress of the manufacturing process of the vehicle 100 from the process management device 500. The determination unit 230 determines contents of confirmation action to be performed by a vehicle. The confirmation action is an action for confirming whether the desired vehicle 100 is remotely controlled. The confirmation action includes, for example, sounding of the horn 160, lighting of the headlamp 170, and swinging of the wiper 180. The action information acquisition unit 240 acquires an action information that is an information about the confirmation action from the external sensor group 300. The judgement unit 250 determines whether the desired vehicle 100 is remotely controlled. When it is determined that the desired vehicle 100 is not remotely controlled, the identification unit 260 identifies the vehicle 100 that the remote control unit 210 erroneously controls.

The external sensor group 300 is constituted of at least one external sensor. The external sensor is a sensor provided outside the vehicle 100. An external sensor is used by the vehicle 100 to observe the acknowledgement action. External sensors include, for example, cameras, LiDAR (Light Detection and Ranging) and microphones. By using a camera or a LiDAR, it is possible to observe the lighting of the headlamp 170 and the swing of the wiper 180. By using a microphone, it is possible to observe the sounding of the horn 160. In the present embodiment, the external sensor group 300 is constituted by a plurality of cameras installed in a factory and a plurality of microphones installed in a factory. Each camera and microphone includes a communications device, not shown, and can communicate with the remote control device 200 via wired or wireless communications.

The notification device 400 is a device for notifying the administrator of the unmanned driving system 10 and workers in the factory of occurrence of abnormality in the factory. In the following description, the administrator of the unmanned driving system 10 and the workers in the factory are referred to as “administrator and the like”. The notification device 400 is, for example, a warning buzzer provided in the factory or a warning lamp provided in the factory. The notification device 400 may be a tablet terminal carried by the administrator and the like. The notification device 400 is equipped with a communication device (not shown), and is capable of communication with the remote control device 200 via wired or wireless communication.

The process management device 500 is a device for managing the production steps of the vehicle 100 in a factory. The process management device 500 is constituted of at least one computer. The process management device 500 is equipped with a communication device (not shown), and is capable of communication with the remote control device 200 and various facilities in the factory via wired or wireless communication. The process control device 500 has information regarding when, where, by whom, on which vehicle 100, and what work is scheduled to be performed. The process control device 500 acquires information regarding when, where, who performed what work, and on which vehicle 100 by communicating with various equipment in the factory.

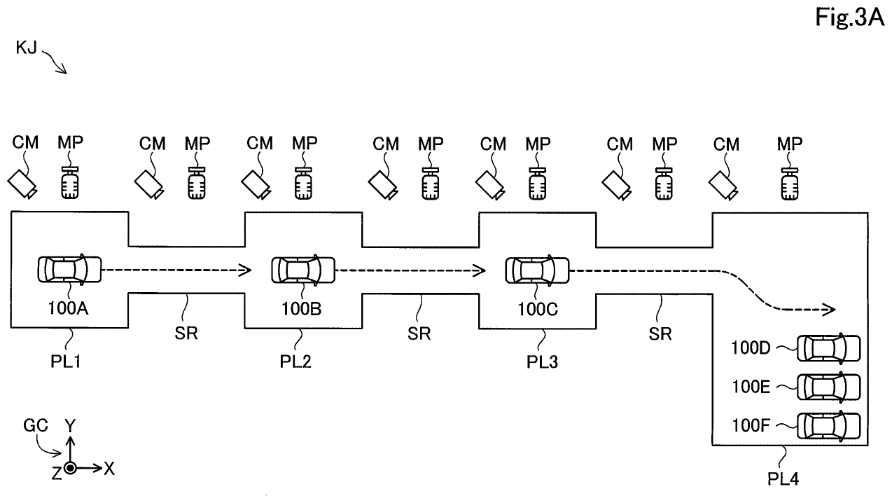

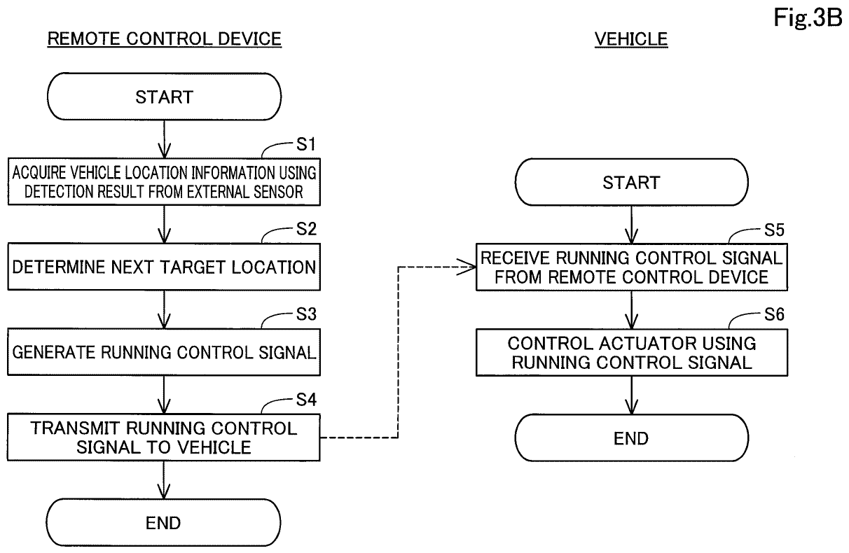

FIG. 3A is an explanatory view of a state in which the vehicle 100 moves by remote control in a factory KJ. FIG. 3A illustrates six vehicles 100A to 100F. In the following description, when the six vehicles 100A to 100F are described without being distinguished from one another, the vehicles 100A to 100F will be simply referred to as the vehicle 100. In the present embodiment, the factory KJ includes a first place PL1, a second place PL2, a third place PL3, and a fourth place PL4. The first place PL1, the second place PL2, and the third place PL3 are locations where work to assemble the vehicle 100 is performed, and the fourth place PL4 is a location where work to inspect the vehicle 100 is performed. The first place PL1, the second place PL2, the third place PL3, and the fourth place PL4 are connected by a track SR on which the vehicles 100 can travel.

The vehicle 100 assembled at the first place PL1 is equipped with the vehicle control device 110, the driving device 120, the steering device 130, the braking device 140, the communication device 150, and the horn 160. The vehicle 100 assembled in the first place PL1 travels from the first place PL1 to the second place PL2 by the remote control. At the second place PL2, the headlamp 170 is installed on the vehicle 100. The vehicle 100 installed the headlamps 170 travels from the second place PL2 to the third place PL3 by the remote control. At the third place PL3, the wiper 180 is installed on the vehicle 100. The vehicles 100 installed the wiper 180 travels from the third place PL3 to the fourth place PL4 by the remote control. At the fourth place PL4, the vehicle 100 is inspected. The vehicle 100 is then shipped from the factory KJ. In the following explanation, the work performed in the first place PL1 is referred to as the first step, the work performed in the second place PL2 is referred to as the second step, the work performed in the third place PL3 is referred to as the third step, and the work performed in the fourth place PL4 is referred to as the fourth step. The first step, the second step, the third step, and the fourth step are included in the manufacturing process of the vehicle 100.

The following provides a description of a method of causing the vehicle 100 to move by remote control using the remote control unit 210. The remote control unit 210 determines a target route for allowing the vehicle 100 to run to its destination along the track SR. In this embodiment, the target route is a reference route RR. The factory KJ is equipped with a plurality of cameras CM that capture images of the track SR, and the remote control unit 210 can acquire the relative position and orientation of the vehicle 100 relative to the target route in real time by analyzing the video images captured by each of the cameras CM. In the present embodiment, each camera CM is included in the external sensor group 300 described above. The remote control unit 210 generates control commands for causing the vehicle 100 to run along the target route, and transmits the control commands to the vehicle 100. In the present embodiment, the control command includes a travel control signal to be described later. The vehicle control device 110 mounted on the vehicle 100 controls the driving device 120, the steering device 130, and the braking device 140 according to the received control commands, thereby causing the vehicle 100 to run. This allows the vehicle 100 to move without using transport devices, such as a crane, a conveyor, or the like. In the present embodiment, the control command, for example, the target value of the acceleration of the vehicle 100 and the target value of the steering angle are shown. In other embodiments, the control command, the target route of the vehicle 100 may be shown. In this case, the vehicle control unit 115 may determine the target value of the acceleration of the vehicle 100 or the target value of the steering angle from the target route.

In the present embodiment, the remote control unit 210 causes the plurality of vehicles 100A to 100F to run one by one by remote control. For example, the remote control unit 210 moves the vehicle 100C from the third place PL3 to the fourth place PL4 by the remote control, and then switches the remote control target from the vehicle 100C to the vehicle 100B. The remote control unit 210 moves the vehicle 100B from the second place PL2 to the third place PL3 by the remote control. The remote control unit 210 moves the vehicle 100B from the second place PL2 to the third place PL3 by remote control, and then switches the remote control target from the vehicle 100B to the vehicle 100A. The remote control unit 210 moves the vehicle 100A from the first place PL1 to the second place PL2 by the remote control. In the present embodiment, the remote control unit 210 is also capable of causing the plurality of vehicles 100A to 100F simultaneously and in parallel by remote control. For example, the remote control unit 210 moves the vehicle 100B from the second place PL2 to the third place PL3 by the remote control while moving the vehicle 100C from the third place PL3 to the fourth place PL4 by the remote control. The remote control unit 210 moves the vehicle 100A from the first place PL1 to the second place PL2 by the remote control while moving the vehicle 100B from the second place PL2 to the third place PL3 by the remote control.

FIG. 3B is a flowchart of procedures in the process of running control of the vehicle 100 in the first embodiment. The step S1 to the step S4 are repeated by the processor 201 of the remote control device 200, and the step S5 to the step S6 are repeated by the processor 111 of the vehicle control device 110. In the step S1, the remote control device 200 acquires vehicle location information of the vehicle 100 using detection results output from the external sensor, which is a sensor located outside the vehicle 100. The vehicle location information is position information that serves as the basis for generating running control signals. In the present embodiment, the vehicle location information includes the position and orientation of the vehicle 100 in the reference coordinate system of the factory KJ. In the present embodiment, the reference coordinate system of the factory KJ is the global coordinate system GC, and any location in the factory KJ is expressed with X, Y, and Z coordinates in the global coordinate system GC. In the present embodiment, the external sensor is the camera CM, and the external sensor outputs a captured image as a detection result. That is, in the step S1, the remote control device 200 acquires the vehicle location information using captured images acquired from the camera CM, which is the external sensor.

More specifically, in step S1, the remote control device 200 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GC, thereby acquiring the location of the vehicle 100. The outer shape of the vehicle 100 in the captured image may be detected by inputting the captured image to a detection model DM using artificial intelligence, for example. The detection model DM is prepared in the unmanned driving system 10 or outside the unmanned driving system 10. The detection model DM is stored in advance in the memory 202 of the remote control device 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model DM and the label. The remote control device 200 can acquire the orientation of the vehicle 100 through estimation based on the direction of a motion vector of the vehicle 100 detected from change in location of a feature point of the vehicle 100 between frames of the captured images using optical flow process, for example.

In step S2, the remote control device 200 determines a target location to which the vehicle 100 is to move next. In the present embodiment, the target location is expressed by X, Y, and Z coordinates in the global coordinate system GC. The memory 202 of the remote control device 200 contains the reference route RR stored in advance as a route along which the vehicle 100 is to run. The route is expressed by a node indicating a departure place, a node indicating a way point, a node indicating a destination, and a link connecting nodes to each other. The remote control device 200 determines the target location to which the vehicle 100 is to move next using the vehicle location information and the reference route RR. The remote control device 200 determines the target location on the reference route RR ahead of a current location of the vehicle 100.

In step S3, the remote control device 200 generates a running control signal for causing the vehicle 100 to run toward the determined target location. In the present embodiment, the running control signal includes an acceleration and a steering angle of the vehicle 100 as parameters. The remote control device 200 calculates a running speed of the vehicle 100 from transition of the location of the vehicle 100 and makes comparison between the calculated running speed and a target speed of the vehicle 100 determined in advance. If the running speed is lower than the target speed, the remote control device 200 generally determines an acceleration in such a manner as to accelerate the vehicle 100. If the running speed is higher than the target speed as, the remote control device 200 generally determines an acceleration in such a manner as to decelerate the vehicle 100. If the vehicle 100 is on the reference route RR, The remote control device 200 determines a steering angle and an acceleration in such a manner as to prevent the vehicle 100 from deviating from the reference route RR. If the vehicle 100 is not on the reference route RR, in other words, if the vehicle 100 deviates from the reference route RR, the remote control device 200 determines a steering angle and an acceleration in such a manner as to return the vehicle 100 to the reference route RR. In other embodiments, the running control signal may include the speed of the vehicle 100 as a parameter instead of or in addition to the acceleration of the vehicle 100.

In step S4, the remote control device 200 transmits the generated running control signal to the vehicle 100. The remote control device 200 repeats the acquisition of vehicle location information, the determination of a target location, the generation of a running control signal, the transmission of the running control signal, and others in a predetermined cycle.

In step S5, the vehicle control device 110 of the vehicle 100 receives the running control signal transmitted from the remote control device 200. In step S6, the vehicle control device 110 controls the driving device 120, the steering device 130, and the braking device 140 using the received running control signal, thereby causing the vehicle 100 to run at the acceleration and the steering angle indicated by the running control signal. The vehicle control device 110 repeats the reception of a running control signal and the control over the various devices 120 to 140 in a predetermined cycle.

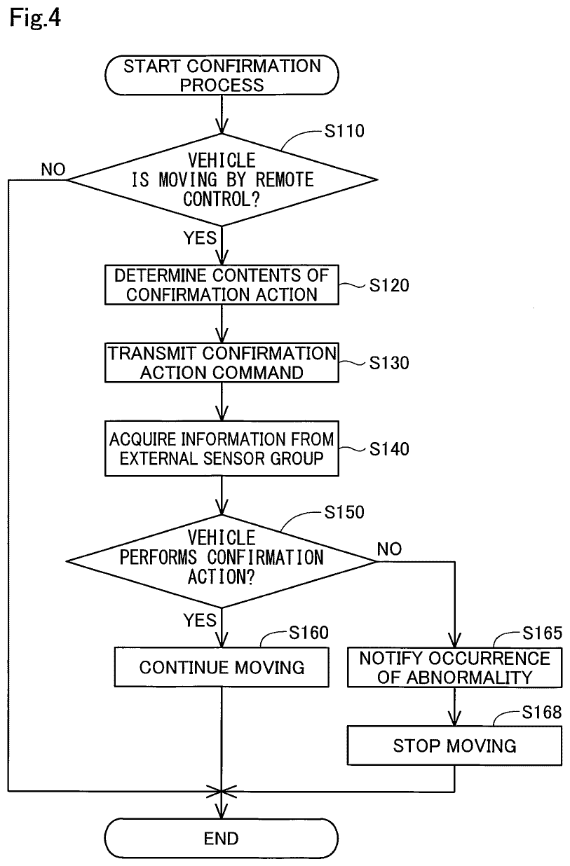

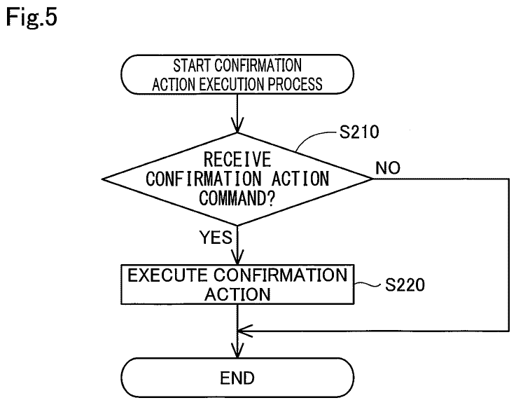

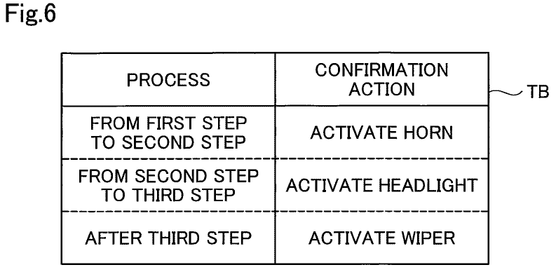

FIG. 4 is a flowchart showing the content of a confirmation process executed by the remote control device 200. FIG. 5 is a flowchart showing the contents of a confirmation action execution process executed in the vehicle 100. FIG. 6 is an explanatory diagram illustrating contents of a table TB illustrating the relation between the manufacturing process and the confirmation action of the vehicle 100. Referring to FIGS. 4 to 6, a control method to be performed in the unmanned driving system 10 will be described.

The confirmation process shown in FIG. 4 is repeatedly performed by the processor 201 of the remote control device 200. When the confirmation process is started, In step S110, the remote control unit 210 determines whether or not the moving of the vehicle 100 by the remote control is being executed. In the following description, the vehicle 100 that the remote control unit 210 is recognized as a remote control target is referred to as a target vehicle 100. If it is determined that the vehicle 100 is not being moved by the remote control in the step S110, the remote control unit 210 skips the process after step S110 and ends the confirmation process.

If it is determined that the target vehicle 100 is being moved by remote control in step S110, the determination unit 230 determines, in step S120, the contents of the confirmation action for causing the target vehicle 100 to perform. In the present exemplary embodiment, the determination unit 230 determines the contents of the confirmation action to be executed by the target vehicle 100 according to the progress of the manufacturing process of the target vehicle 100. As illustrated in FIG. 6, in the table TB stored in the memory 202, the progress of the manufacturing process of the vehicle 100 and the content of the confirmation action are recorded in association with each other. The process information acquisition unit 220 acquires process information indicating the degree of progress of the manufacturing process of the target vehicle 100 from the process management device 500, and the determination unit 230 determines the content of the confirmation action to be executed by the target vehicle 100 using the process information acquired by the process information acquisition unit 220 and the table TB. For example, when the manufacturing process of the target vehicle 100 has progressed between the first process and the second process, the determination unit 230 determines that the confirmation action to be performed by the target vehicle 100 is to cause the horn 160 to sound. When the manufacturing process of the target vehicle 100 has progressed to between the second process and the third process, the determination unit 230 determines that the confirmation action to be performed by the target vehicle 100 is to turn on the headlamp 170. When the manufacturing process of the target vehicle 100 has progressed to the third process or later, the determination unit 230 determines that the confirmation action to be performed by the target vehicle 100 is swinging the wiper 180.

In step S130, the remote control unit 210 transmits a control command for causing the target vehicle 100 to perform the confirmation action. In the following description, the control command for causing the target vehicle 100 to perform the confirmation action is referred to as confirmation action command.

In step S140, the action information acquisition unit 240 acquires action information regarding the confirmation action from the external sensor group 300. In the present embodiment, the external sensor group 300 includes a plurality of microphone MP and a plurality of camera CM, and action information includes information representing audio obtained from each microphone MP and information representing video obtained from each camera CM.

In step S150, the judgement unit 250 judges whether or not the target vehicle 100 has performed the confirmation action in response to the confirmation action command. In the present embodiment, when the action information indicates that the target vehicle 100 has performed the confirmation action, the judgement unit 250 judges that the target vehicle 100 has performed the confirmation action in response to the confirmation action command. When the action information does not indicate that the target vehicle 100 has performed the confirmation action, the judgement unit 250 judges that the target vehicle 100 has not performed the confirmation action in response to the confirmation action command.

When the judgement unit 250 judges that the target vehicle 100 has performed the confirmation action in response to the confirmation action command in step S150, the remote control unit 210, in step S160, continues to move by the remote control of the target vehicle 100. Thereafter, the remote control device 200 ends the confirmation process.

When the judgement unit 250 judges that the target vehicle 100 has not performed the confirmation action in response to the confirmation action command in step S150, the remote control unit 210, in step S165, using the notification device 400, and notifies the manager or the like that an abnormality has occurred. In this embodiment, the identification unit 260 identifies a vehicle 100 other than the target vehicle 100 that executed the confirmation motion at the timing when the confirmation action command was transmitted, uses the action information. In other words, the identification unit 260 identifies the vehicle 100 that is being erroneously remotely controlled by the remote control unit 210. The remote control unit 210, in addition to the occurrence of abnormality, may notify the identification number and the current location of the vehicle 100 that is being erroneously remotely controlled to the manager or the like. In step S168, The remote control unit 210 stops the movement of the vehicle 100 that is being erroneously controlled remotely by transmitting a control command to brake the vehicle 100. The order of step S165 and step S168 may be reversed. Thereafter, the remote control device 200 ends the confirmation process.

The confirmation action execution process shown in FIG. 5 is repeatedly executed in the vehicle 100. When the confirmation action execution process is started, in steps S210, the vehicle control unit 115 determines whether or not it has received the confirmation action command from the remote control device 200. If it is not determined that the confirmation action command has been received from the remote control device 200 in step S210, the vehicle control unit 115 skips the process after step S210, and ends the confirmation action execution process. If it is determined that it has received the confirmation action command from the remote control device 200 in step S210, the vehicle control unit 115 causes vehicle 100 to perform a confirmation action in accordance with the confirmation action command in step S220. Thereafter, the vehicle control unit 115 ends the confirmation action execution process.

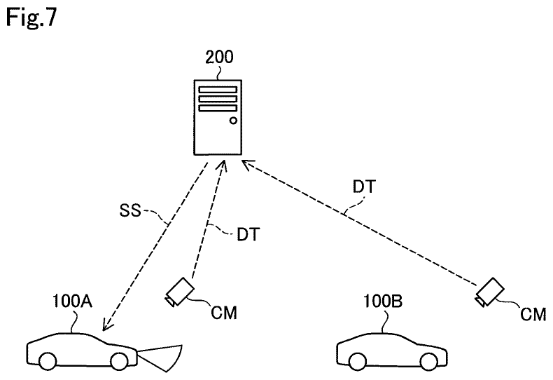

FIG. 7 is an explanatory diagram showing a state of confirming whether or not to remotely control the desired object. For example, when the vehicle 100A is being moved by remote control from the second place PL2 to the third place PL3, in other words, when the manufacturing process of the vehicle 100A is proceeding to between the second step and the third step, in the confirmation process, the confirmation action command SS for lighting the headlamp 170 is transmitted from the remote control device 200. If the image obtained from the camera CM shows that the headlamp 170 of the vehicle 100A is turned on in response to the confirmation operation command SS, it can be confirmed that the remote control device 200 is remotely controlling the vehicle 100A that is an appropriate target. In this event, the remote control device 200 continues to move the vehicular 100A. In contrast, if the headlamp 170 of the vehicle 100A does not light in response to the confirmation action command SS, the remote control device 200 may have mistakenly remote control of a different vehicle 100 from the vehicle 100A. For example, if the headlamp 170 of the vehicle 100B at the timing when the confirmation action command SS is transmitted is turned on, the remote control device 200 may have erroneously controlled the vehicle 100B. In this case, the remote control device 200, after notifying the administrator or the like that the abnormality occurs by the notification device 400, stops the movement of the vehicle 100 that is accidentally remote control by remote control.

According to the unmanned driving system 10 in the present embodiment described above, the remote control device 200 continues the movement of the vehicle 100 when the object of remote control is appropriate, and when the object of remote control is not appropriate, the notification device 400 notifies the administrator or the like of the occurrence of an abnormality, and stops the movement of the vehicle 100 that is erroneously remotely controlled by remote control. Therefore, it can be properly addressed when the object of remote control is not appropriate.

Further, in the present embodiment, when the object of the remote control is not appropriate, the vehicle 100 that the remote control device 200 is accidentally remote control can be identified by the identification unit 260. Therefore, when the object of remote control is not appropriate, it is possible to take appropriate action quickly.

Further, in the present embodiment, the content of the confirmation action is determined according to the progress of the manufacturing process of the vehicle 100. Therefore, it is possible to increase the determination accuracy of whether the object of remote control is appropriate.

Further, when the remote control device 200 performs remote control on a plurality of vehicles 100, it is possible that a control command is transmitted from the communication device 205 to a vehicle 100 that does not correspond to the control command. The “transmission of a control command from the communication device 205 to a vehicle 100 that does not correspond to the control command” here means that a control command generated for remote control of a particular one of the plurality of vehicles 100 is transmitted from the communication device 205 to another vehicle 100 other than the one vehicle 100. Such an event may be referred to as mistaken identification of the vehicle 100 that is subjected to remote control. When the remote control device 200 performs remote control on a plurality of vehicles 100, malfunctions in the unmanned driving system 10 or other human errors by the workers in the factory KJ may result in mistaken identification of the target vehicle 100 subjected to remote control. For example, as shown in FIG. 3A, when the remote control device 200 performs remote control on six vehicles: the vehicle 100F, the vehicle 100E, the vehicle 100D, the vehicle 100C, the vehicle 100B, and the vehicle 100A in this order, it is possible that a control command is transmitted from the communication device 205 to a vehicle 100 that does not correspond to the control command. Specifically, after the remote control device 200 has completed remote control of the vehicle 100F, if the communication device 150 removed from the vehicle 100F is mistakenly attached to the vehicle 100A even though the communication device 150 removed from the vehicle 100F was scheduled to be attached to the vehicle 100B, it is possible that a control command generated for the remote control of the vehicle 100B is transmitted to the vehicle 100A. Even in such a case, according to the present embodiment, the remote control device 200 is capable of detecting the mistaken identification of the vehicle 100 subjected to remote control by performing the confirmation process. Therefore, it is possible to detach the communication device 150 mistakenly attached to the vehicle 100A from the vehicle 100A, and attach it to the vehicle 100B, thereby starting remote control of the vehicle 100B.

### B. Second Embodiment

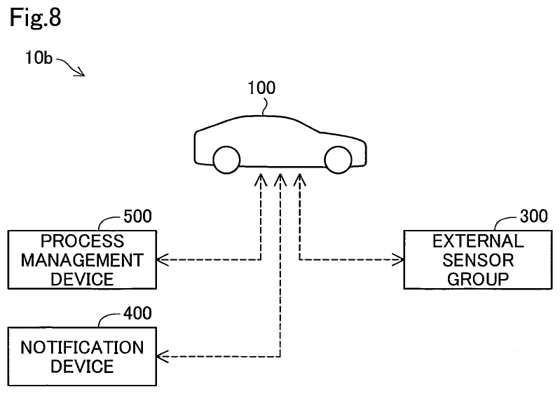

FIG. 8 is an explanatory view of a structure of an unmanned driving system 10b according to a second embodiment. FIG. 8 is an explanatory view of a structure of a vehicle 100 according to the second embodiment. The second embodiment differs from the first embodiment in that the unmanned driving system 10b does not have the remote control device 200, and that the vehicle 100 runs by autonomous control instead of remote control. Other structures are the same as those in the first embodiment, unless otherwise specified. In the present embodiment, the vehicle control device 110 corresponds to the “control device” of the present disclosure.

As shown in FIG. 8, in the present embodiment, the vehicle 100 is configured to be able to travel by autonomous control. The vehicle 100 can communicate with the external sensor group 300. the notification device 400 and the process management device 500 through wireless communication using the communication device 150.

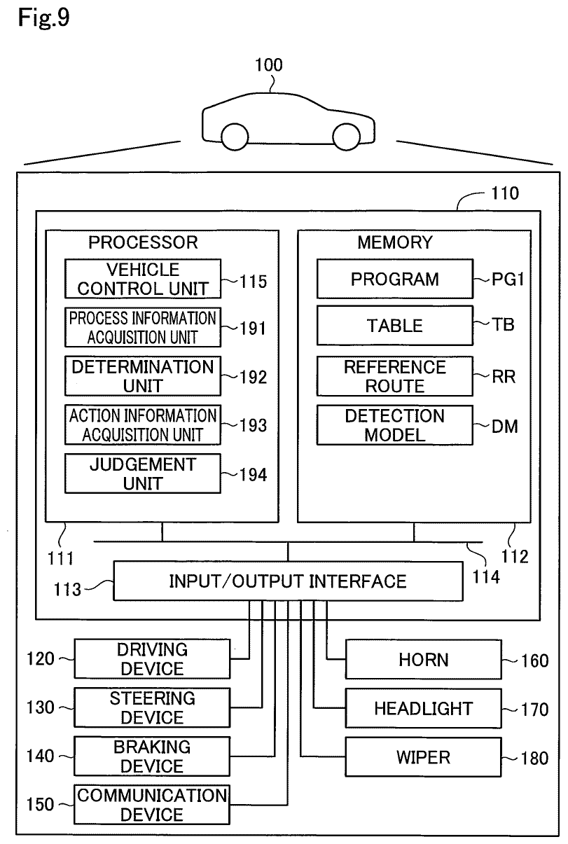

As shown in FIG. 9, the processor 111 of the vehicle control device 110 functions as the vehicle control unit 115, the process information acquisition unit 191, the determination unit 192, the action information acquisition unit 193, and the judgement unit 194 by executing a computer program PG1 previously stored in the memory 112. The process information acquisition unit 191 acquires process information from the process management device 500. The determination unit 192 determines the contents of the confirmation action to be executed by the own vehicle. In the present exemplary embodiment, the confirmation action is performed in order to check whether the detection result acquired from the camera CM of the external sensor group 300 is the detection result of detecting the own vehicle. In other words, in the present embodiment, the confirmation action is performed in order to confirm whether the position of the own vehicle that the vehicle control device 110 is recognizing is correct. The action information acquisition unit 193 acquires the action information from the external sensor group 300. The judgement unit 194 determines whether the position of the own vehicle the vehicle control device 110 is recognized is correct. In the present embodiment, the table TB, the reference route RR, and the detection model DM are previously stored in the memory 112.

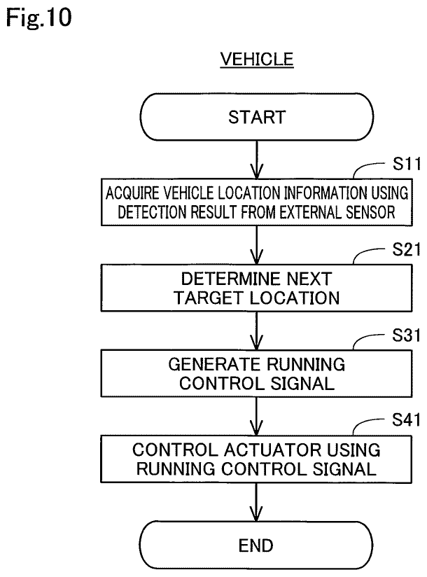

FIG. 10 is a flowchart showing a processing procedure for running control of the vehicle 100 in the present embodiment. In step S11, the vehicle control device 110 acquires vehicle location information using detection result output from the camera CM as the external sensor. In step S21, the vehicle control device 110 determines a target location to which the vehicle 100 is to move next. In step S31, the vehicle control device 110 generates a running control signal for causing the vehicle 100 to run to the determined target location. In step S41, the vehicle control device 110 controls the driving device 120, the steering device 130, and the braking device 140 using the generated running control signal, thereby causing the vehicle 100 to run by following a parameter indicated by the running control signal. The vehicle control device 110 repeats the acquisition of vehicle location information, the determination of a target location, the generation of a running control signal, and the control over the various devices 120 to 140 in a predetermined cycle.

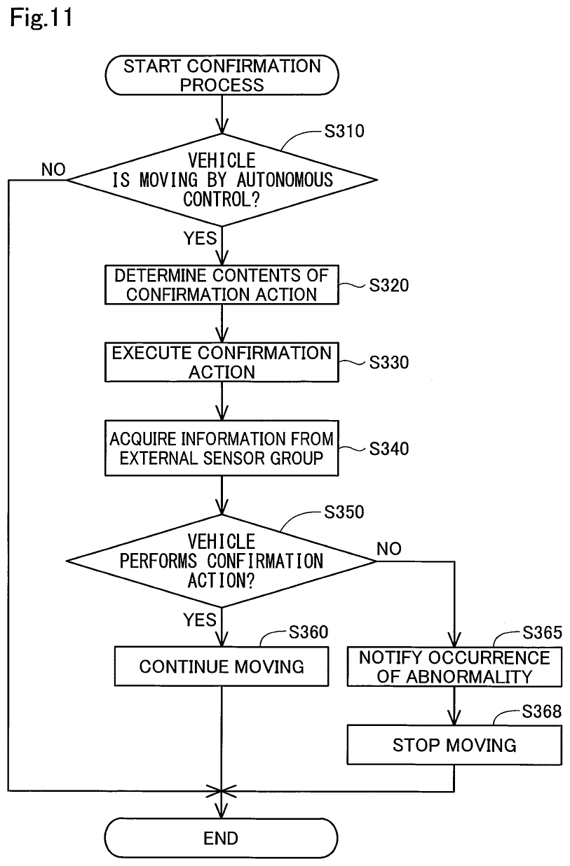

FIG. 11 is a flowchart showing contents of a confirmation process in the present embodiment. The confirmation process shown in FIG. 11 is repeatedly executed by the processor 111 of the vehicle control device 110. When the confirmation process is started, in step S310, the vehicle control unit 115 determines whether or not the autonomous vehicle is moving under autonomous control. If it is determined that the vehicle is not being moved in step S310, the vehicle control unit 115 skips the process after step S310 and ends the confirmation process.

If it is determined that the vehicle is moving in step S310, the determination unit 192 determines the contents of the confirmation action to be performed by the vehicle in step S320. In the present exemplary embodiment, the determination unit 192 determines the contents of the confirmation action to be executed by the own vehicle in accordance with the progress of the manufacturing process of the own vehicle. The table TB stored in the memory 112 is recorded in association with the content of the progress and the confirmation action of the manufacturing process of the vehicle 100. The process information acquisition unit 191 acquires process information indicating the degree of progress of the manufacturing process of the own vehicle from the process management device 500, and the determination unit 192 determines the content of the confirmation action to be executed by the own vehicle using the process information acquired by the process information acquisition unit 191 and the table TB.

In step S330, the vehicle control unit 115 controls each unit of the own vehicle to cause the own vehicle to perform the confirmation action determined by the determination unit 192. In step S340, the action information acquisition unit 193 acquires action information regarding the confirmation action from the external sensor group 300. The action information acquisition unit 193, for example, determines an external sensor that is estimated to have observed the confirmation action of the own vehicle from among a plurality of external sensors included in the external sensor group 300 on the basis of the vehicle position information of the own vehicle recognized by the vehicle control unit 115 and acquires the action information from the external sensor. In step S350, the judgement unit 194 judges whether or not the own vehicle has performed the confirmation action. In the present exemplary embodiment, the judgement unit 194 judges that the own vehicle has performed the confirmation action when it is represented in the action information. The judgement unit 194 judges that the own vehicle has not performed the confirmation action when it is not represented in the action information.

When the judgement unit 194 judges that the own vehicle has performed the confirmation action in step S350, the vehicle control unit 115 continues to move by the autonomous control of the autonomous vehicle in step S360. Thereafter, the vehicle control device 110 ends the confirmation process. In contrast, when the judgement unit 194 judges that the own vehicle has not performed the confirmation action in step S350, the vehicle control unit 115, in step S365, uses the notification device 400 to notify the manager or the like that an error has occurred. In step S368, the vehicle control unit 115 brakes the own vehicle. The order of step S365 and step S368 may be reversed. Thereafter, the vehicle control device 110 ends the confirmation process.

According to the unmanned driving system 10b in the present embodiment described above, even without remotely controlling the vehicle 100 from the outside, it is possible to run the vehicle 100 by the autonomous control of the vehicle 100. Further, in the present exemplary embodiment, the vehicle 100 can confirm whether or not the position info of its own vehicle acquired by using the camera CM of the external sensor group 300 is correct by executing the confirmation process.

### C. Alternative Embodiments

(C1) In the unmanned driving systems 10 and 10b of the above described embodiments, the remote control device 200 and the vehicle control device 110 have caused the vehicle 100 to perform an acknowledge operation while the vehicle 100 is moving. In contrast, the remote control device 200 and the vehicle control device 110, while stopping the movement of the vehicle 100, may cause the vehicle 100 to perform the confirmation action.

(C2) In the unmanned driving systems 10 and 10b of the above described embodiments, the determination units 230 and 192 determine the contents of the confirmation action in accordance with the progress of the manufacturing process of the vehicle 100. In contrast, the determination units 230 and 192 may determine the content of the confirmation action in accordance with the degree of advance and time of the manufacturing process of the vehicle 100. For example, when the vehicle 100 travels outdoors from the second place PL2 to the third place PL3, the determination units 230 and 192 may determine the sounding of the horn 160 for confirmation action during daytime hours and determine the lighting of the headlamp 170 for confirmation action during nighttime hours. Alternatively, the determination units 230 and 192 may determine the content of the confirmation action in accordance with the progress of the manufacturing process of the vehicle 100 and the weather of the site. For example, when the vehicle 100 travels outdoors from the third place PL3 to the fourth place PL4, the determination units 230 and 192 may determine the swing of the wiper 180 for confirmation action in fine weather and determine the lighting of the headlamp 170 for confirmation action in rainy weather. In the process in which the work noise is high, the determination units 230 and 192 may determine the lighting of the headlamp 170 or the swing of the wiper 180 for confirmation action instead of the sounding of the horn 160. The determination units 230 and 192 may determine the content of the confirmation action regardless of the progress of the manufacturing process of the vehicle 100. For example, the determination units 230 and 192 may determine the content of the confirmation action in accordance with at least one of the weather and the time regardless of the progress of the manufacturing process of the vehicle 100.

(C3) In the unmanned driving systems 10 and 10b of the above described embodiments, the remote control unit 210 and the vehicle control unit 115, in steps S168 and S368 of the confirmation process, to stop the movement of the vehicle 100. In contrast, the remote control unit 210 and the vehicle control unit 115, in the confirmation process, it may not stop the movement of the vehicle 100. For example, the remote control unit 210 and the vehicle control unit 115 may decelerate the vehicle 100 to the extent that the vehicle 100 does not stop in steps S168 and S368 of the confirmation process. The remote control unit 210 and the vehicle control unit 115 may continue to move the vehicle 100 while lowering the upper limit of the moving speed of the vehicle 100 compared to before steps S168 and S368 of the confirmation process.

(C4) In the unmanned driving system 10 of the first embodiment described above, the remote control unit 210, when a plurality of vehicles 100 are simultaneously and in parallel remote control, in step S168 of the confirmation process, all of the vehicles 100 in the remote control It is stopped at once. In contrast, the remote control unit 210 may stop only the movement of the vehicle 100 identified by the identification unit 260.

(C5) In the unmanned driving system 10 of the first embodiment described above, the remote control unit 210, when a plurality of vehicles 100 are simultaneously and in parallel remote control, in step S168 of the confirmation process, the vehicle 100 located around the target vehicle 100 by the remote control it may be moved to a predetermined an escape place. The escape place may be, for example, provided at the end of the track SR or may be provided branched from the track SR.

(C6) In the unmanned driving system 10 of the first embodiment described above, the remote control device 200 includes the identification unit 260. In contrast, the remote control device 200 may not include the identification unit 260.

(C7) In the unmanned driving system 10 of the first embodiment described above, the action information acquisition unit 240 and the judgement unit 250 are provided in the remote control device 200. In contrast, the action information acquisition unit 240 and the judgement unit 250 may be provided in the vehicle control device 110. In this case, the remote control device 200 acquires the determination result from the vehicle control device 110, the processing for the vehicle 100 according to the acquired determination result may be different.

(C8) In the unmanned driving systems 10 and 10b in the embodiments described above, the external sensor is not limited to the camera but may be the distance measuring device, for example. The distance measuring device is a light detection and ranging (LiDAR) device, for example. In this case, detection result output from the external sensor may be three-dimensional point cloud data representing the vehicle 100. The remote control device 200 and the vehicle 100 may acquire the vehicle location information through template matching using the three-dimensional point cloud data as the detection result and reference point cloud data, for example.

(C9) In the unmanned driving system 10 of the first embodiment described above, the remote control device 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The remote control device 200 may acquire vehicle location information, determine a target location to which the vehicle 100 is to move next, and generate a route from a current location of the vehicle 100 indicated by the acquired vehicle location information to the target location. The remote control device 200 may generate a route to the target location between the current location and a destination or generate a route to the destination. The remote control device 200 may transmit the generated route to the vehicle 100. The vehicle 100 may generate a running control signal in such a manner as to cause the vehicle 100 to run along the route received from the remote control device 200 and control the driving device 120, the steering device 130, and the braking device 140 using the generated running control signal.

(2) The remote control device 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the driving device 120, the steering device 130, and the braking device 140 using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the remote control device 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(C10) In the unmanned driving system 10b of the second embodiment described above, the vehicle 100 may be equipped with an internal sensor, and detection result output from the internal sensor may be used in at least one of generation of a route and generation of a running control signal. For example, the vehicle 100 may acquire detection result from the internal sensor, and in generating the route, may reflect the detection result from the internal sensor in the route. The vehicle 100 may acquire detection result from the internal sensor, and in generating the running control signal, may reflect the detection result from the internal sensor in the running control signal.

(C11) In the unmanned driving system 10b of the second embodiment described above, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control the driving device 120, the steering device 130, and the braking device 140 of the vehicle 100 using the generated running control signal. In this case, the vehicle 100 is capable of running without using any detection result from the external sensor. The vehicle 100 may acquire target arrival time or traffic congestion information from outside the vehicle 100 and reflect the target arrival time or traffic congestion information in at least one of the route and the running control signal. The functional configuration of the unmanned driving systems 10 and 10b may be entirely provided at the vehicle 100. Specifically, the processes realized by the unmanned driving systems 10 and 10b in the present disclosure may be realized by the vehicle 100 alone.

(C12) In the first embodiment described above, the remote control device 200 automatically generates the running control signal, which is transmitted to the vehicle 100. Optionally, the remote control device 200 may generate the running control signal, which is transmitted to the vehicle 100, according to an operation by an external operator located outside the vehicle 100. For example, the external operator may operate an operating device equipped with a display for displaying captured images output from the camera CM, which is an external sensor, a steering wheel, an accelerator pedal, and a brake pedal for enabling remote control of the vehicle 100, and a communication device for enabling communication with the remote control device 200 via wired or wireless communication, and the remote control device 200 may generate the running control signal in response to the operation made on the operating device. In this embodiment, the captured image of the target vehicle 100 is displayed on the display of the control device, the confirmation of whether the target vehicle 100 in the confirmation process has executed the confirmation action may be performed by visual confirmation of the operator.

(C13) In each of the above-described embodiments, the vehicle 100 is simply required to have a configuration to become movable by unmanned driving. The vehicle 100 may embodied as a platform having the following configuration, for example. The vehicle 100 is simply required to include at least the vehicle control device 110, the driving device 120, the steering device 130, and the braking device 140 in order to fulfill three functions including “run,” “turn,” and “stop” by unmanned driving. In order for the vehicle 100 to acquire information from outside for unmanned driving, the vehicle 100 is simply required to include the communication device 150 further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from the factory KJ, or a remaining component such as a bodyshell may be mounted on the vehicle 100 after the vehicle 100 is shipped from the factory KJ while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.

(C14) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(C15) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

(C16) The control and the method described in the present disclosure may be realized by a dedicated computer provided by configuring a processor and a memory programmed in such a manner as to implement one or a plurality of functions embodied by a computer program. Alternatively, the controller and the method described in the present disclosure may be realized by a dedicated computer provided by configuring a processor using one or more dedicated hardware logic circuits. Still alternatively, the controller and the method described in the present disclosure may be realized by one or more dedicated computers configured using a combination of a processor and a memory programmed in such a manner as to implement one or a plurality of functions, and a processor configured using one or more hardware logic circuits. The computer program may be stored as an instruction to be executed by a computer into a computer-readable tangible non-transitory recording medium.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. A control device, comprising:
a determination unit configured to determine an action to be performed by a moving object, wherein the moving object is operable by unmanned driving;
a control unit configured to cause a controlled moving object to perform the action while the controlled moving object is moving, wherein the controlled moving object is a moving object that is operated by the unmanned driving;
an action information acquisition unit configured to acquire an action information, wherein the action information is an information regarding the action that is observed from the outside a moving object; and
a judgement unit configured to judge whether or not the controlled moving object has performed the action using the action information,
wherein when the judgement unit judges that the controlled moving object has not performed the action, the control unit executes at least one of a process of notifying occurrence of abnormality, a process of stopping the controlled moving object, and a process of changing a speed of the controlled moving object.

2. The control device according to claim 1, wherein
the controlled moving object is a part of a plurality of moving objects operable by the unmanned driving,
the control device further comprises an identification unit configured to identify the controlled moving object from among the plurality of the moving objects using the action information, wherein when the judgement unit judges that the controlled moving objects has not performed the action, the identification unit identifies the controlled moving object from among the plurality of the moving objects.

3. The control device according to claim 1, wherein
the controlled moving object is a part of a plurality of moving objects operable by the unmanned driving,
when the judgement unit judges that the controlled moving objects has not performed the action, the control unit moves the controlled moving object to a predetermined escape place.

4. The control device according to claim 1, wherein
the control device further comprises a process information acquisition unit configured to acquire a process information, the process information is an information regarding a progress of a manufacturing process of the moving object, and
the determination unit determines the action according to the progress indicated in the process information.

5. A control method, comprising:
determining an action to be performed by a moving object, wherein the moving object is operable by unmanned driving;
operating a controlled moving object, wherein the operating causes the controlled moving object to perform the action while the controlled moving object is moving, wherein the controlled moving object is a moving object that is operated by the unmanned operation;
acquiring an action information, wherein the action information is an information regarding the action that is observed from the outside a moving object; and
judging whether or not the controlled moving object has performed the action using the action information,
wherein when the judging judges that the controlled moving object has not performed the action, the operating executes at least one of a process of notifying occurrence of abnormality, a process of stopping the controlled moving object, and a process of changing a speed of the controlled moving object.
